(19) United States
(12) Patent Application Publication
(10) Pub. No.: US 2022/0381913 A1
(43) Pub. Date: Dec. 1, 2022

(54) DISTANCE MEASUREMENT SENSOR, SIGNAL PROCESSING METHOD, AND DISTANCE MEASUREMENT MODULE

(71) Applicant: SONY SEMICONDUCTOR SOLUTIONS CORPORATION, KANAGAWA (JP)

(72) Inventors: TAKAYUKI JOBA, KANAGAWA (JP); YASUHIRO OKAMOTO, KANAGAWA (JP); TETSUYA YAMATO, KANAGAWA (JP)

(21) Appl. No.: 17/753,995

(22) PCT Filed: Sep. 16, 2020
(86) PCT No.: PCT/JP2020/035008

§ 371 Date: Mar. 21, 2022

(30) Foreign Application Priority Data
Sep. 30, 2019 (JP) 2019-180931

(51) Int. Cl. G01S 17/36; G01S 17/89; G01S 7/4913

(52) U.S. Cl. CPC G01S 17/36; G01S 17/89; G01S 7/4913

(57) ABSTRACT

The present technology relates to a distance measurement sensor, a signal processing method, and a distance measurement module that make it possible to detect that an object to be measured is a specular reflector. The distance measurement sensor includes a signal processing unit that calculates a distance to an object and a degree of confidence, from a signal obtained by a light receiving unit that receives reflected light that is returned light obtained by reflecting irradiation light emitted from a predetermined light emitting source by the object, and outputs a determination flag determining whether the object that is an object to be measured is a specular reflector having a high reflectance. The present technology can be applied to, for example, a distance measurement module that measures a distance to a subject, and the like.

### TECHNICAL FIELD

The present technology relates to a distance measurement sensor, a signal processing method, and a distance measurement module, and more particularly, to a distance measurement sensor, a signal processing method, and a distance measurement module enabled to detect that an object to be measured is a specular reflector.

### BACKGROUND ART

In recent years, with the progress of semiconductor technology, downsizing of a distance measurement module that measures a distance to an object has progressed. As a result, for example, it is implemented that the distance measurement module is mounted on a mobile terminal such as a smartphone.

As a distance measurement method in the distance measurement module, for example, there is a method called a time of flight (ToF) method. In the ToF method, light is emitted toward an object and light reflected on a surface of the object is detected, and a distance to the object is calculated on the basis of a measured value obtained by measuring a flight time of the light (see, for example, Patent Document 1).

### CITATION LIST

### Patent Document

### Patent Document 1: Japanese Patent Application Laid-Open No. 2017-150893

### SUMMARY OF THE INVENTION

### Problems to be Solved by the Invention

However, in the ToF method, the distance is calculated by emitting light and receiving reflected light reflected from an object, so that there has been a case where a distance different from an actual distance is measured due to multiple reflection on the surface of the specular reflector, or the like when, for example, a specular reflector such as a mirror or an iron door is measured.

The present technology has been made in view of such a situation, and it is intended to make it possible to detect that an object to be measured is a specular reflector.

### Solutions to Problems

A distance measurement sensor according to a first aspect of the present technology includes a signal processing unit that calculates a distance to an object and a degree of confidence, from a signal obtained by a light receiving unit that receives reflected light that is returned light obtained by reflecting irradiation light emitted from a predetermined light emitting source by the object, and outputs a determination flag determining whether the object that is an object to be measured is a specular reflector having a high reflectance.

In a signal processing method according to the second aspect of the present technology, a distance measurement sensor calculates a distance to an object and a degree of confidence, from a signal obtained by a light receiving unit that receives reflected light that is returned light obtained by reflecting irradiation light emitted from a predetermined light emitting source by the object, and outputs a determination flag determining whether the object that is an object to be measured is a specular reflector having a high reflectance.

A distance measurement module according to a third aspect of the present technology includes: a predetermined light emitting source; and a distance measurement sensor, in which the distance measurement sensor includes a signal processing unit that calculates a distance to an object and a degree of confidence, from a signal obtained by a light receiving unit that receives reflected light that is returned light obtained by reflecting irradiation light emitted from a predetermined light emitting source by the object, and outputs a determination flag determining whether the object that is an object to be measured is a specular reflector having a high reflectance.

In the first to third aspects of the present technology, the distance to the object and the degree of confidence are calculated from the signal obtained by the light receiving unit that receives the reflected light that is the returned light obtained by reflecting the irradiation light emitted from the predetermined light emitting source by the object, and the determination flag is output that determines whether the object that is the object to be measured is the specular reflector having the high reflectance.

The distance measurement sensor and the distance measurement module may be an independent device or a module incorporated in another device.

### BRIEF DESCRIPTION OF DRAWINGS

FIG. 1 is a block diagram illustrating a schematic configuration example of a distance measurement module to which the present technology is applied.

FIG. 2 is a diagram explaining a distance measurement principle of an indirect ToF method.

FIG. 3 is a block diagram illustrating a first configuration example of a distance measurement sensor.

FIG. 4 is a diagram explaining a first threshold value of glass determination processing.

FIG. 5 is a flowchart explaining glass determination processing by the distance measurement sensor according to the first configuration example.

FIG. 6 is a block diagram illustrating a second configuration example of the distance measurement sensor.

FIG. 7 is a diagram explaining a determination expression of a specular determination flag.

FIG. 8 is a flowchart explaining specular determination processing by the distance measurement sensor according to the second configuration example.

FIG. 9 is a diagram explaining a problem that can occur in a very short distance.

FIG. 10 is a block diagram illustrating a third configuration example of the distance measurement sensor.

FIG. 11 is a flowchart explaining very short distance determination processing by the distance measurement sensor according to the third configuration example.

FIG. 12 is a diagram illustrating a relationship between a degree of confidence and a depth value of a determination target pixel.

FIG. 13 is a block diagram illustrating a fourth configuration example of the distance measurement sensor.

FIG. 14 is a block diagram illustrating a configuration example of a smartphone as an electronic device to which the present technology is applied.

FIG. 15 is a block diagram illustrating an example of a schematic configuration of a vehicle control system.

FIG. 16 is an explanatory diagram illustrating an example of installation positions of a vehicle exterior information detecting unit and an imaging unit.

### MODE FOR CARRYING OUT THE INVENTION

Hereinafter, a mode for carrying out the present technology (the mode will be hereinafter referred to as the embodiment) will be described with reference to the accompanying drawings. Note that, in the present specification and the drawings, components having substantially the same functional configuration are denoted by the same reference signs, and redundant explanations will be omitted. The description will be made in the following order.

1. Schematic configuration example of distance measurement module

2. Distance measurement principle of indirect ToF method

3. First configuration example of distance measurement sensor

4. Second configuration example of distance measurement sensor

5. Third configuration example of distance measurement sensor

6. Fourth configuration example of distance measurement sensor

7. Configuration example of electronic device

8. Application example to mobile body

<1. Schematic Configuration Example of Distance Measurement Module>

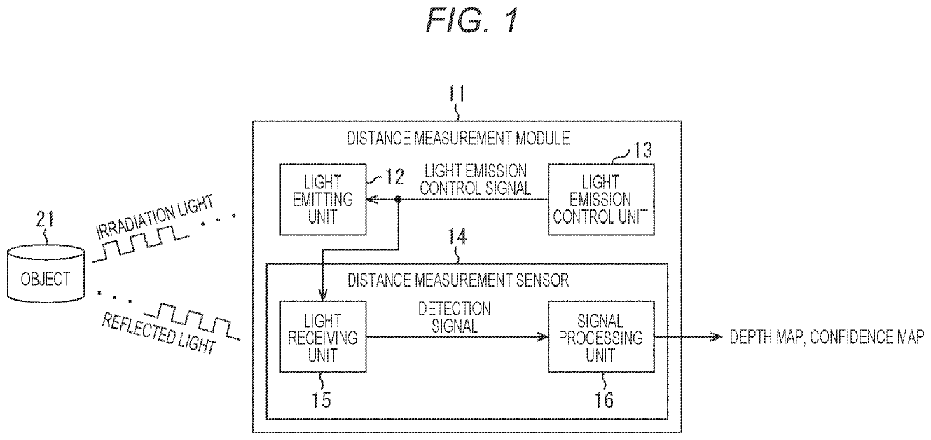

FIG. 1 is a block diagram illustrating a schematic configuration example of a distance measurement module to which the present technology is applied.

A distance measurement module 11 illustrated in FIG. 1 is a distance measurement module that performs distance measurement by an indirect ToF method, and includes a light emitting unit 12, a light emission control unit 13, and a distance measurement sensor 14.

The distance measurement module 11 emits light to a predetermined object 21 as an object to be measured, and receives light (reflected light) obtained by reflecting the light (irradiation light) by the object 21. Then, the distance measurement module 11 outputs a depth map representing distance information to the object 21 and a confidence map, as measurement results, on the basis of the light reception result.

The light emitting unit 12 includes, for example, a vertical cavity surface emitting laser (VCSEL) array (light source array) in which a plurality of VCSELs is arranged in a plane as a light emitting source, and emits light while performing modulation at a timing depending on a light emission control signal supplied from the light emission control unit 13 to emit irradiation light to the object 21. For example, in a case where the irradiation light is infrared light, the wavelength of the irradiation light ranges from about 850 nm to 940 nm.

The light emission control unit 13 supplies the light emission control signal of a predetermined frequency (for example, 20 MHz or the like) to the light emitting unit 12, thereby controlling light emission by the light emitting source. Furthermore, the light emission control unit 13 also supplies the light emission control signal to the distance measurement sensor 14 to drive the distance measurement sensor 14 in accordance with a timing of light emission in the light emitting unit 12.

The distance measurement sensor 14 includes a light receiving unit 15 and a signal processing unit 16.

The light receiving unit 15 receives reflected light from the object 21 by a pixel array in which a plurality of pixels is two-dimensionally arranged in a matrix in the row direction and the column direction. Then, the light receiving unit 15 supplies a detection signal depending on an amount of received light of the received reflected light to the signal processing unit 16 in units of pixels of the pixel array.

The signal processing unit 16 calculates a depth value that is a distance from the distance measurement module 11 to the object 21 on the basis of the detection signal supplied from the light receiving unit 15 for each pixel of the pixel array. Then, the signal processing unit 16 generates a depth map in which the depth value is stored as a pixel value of each pixel and a confidence map in which a confidence value is stored as a pixel value of each pixel, and outputs the depth map and the confidence map to the outside of the module.

Note that, a chip for signal processing such as a digital signal processor (DSP) may be provided at the subsequent stage of the distance measurement module 11, and some of functions executed by the signal processing unit 16 may be performed outside the distance measurement sensor 14 (by the chip for signal processing at the subsequent stage). Alternatively, all of the functions executed by the signal processing unit 16 may be performed by the chip for signal processing at the subsequent stage provided separately from the distance measurement module 11.

<2. Distance Measurement Principle of Indirect ToF Method>

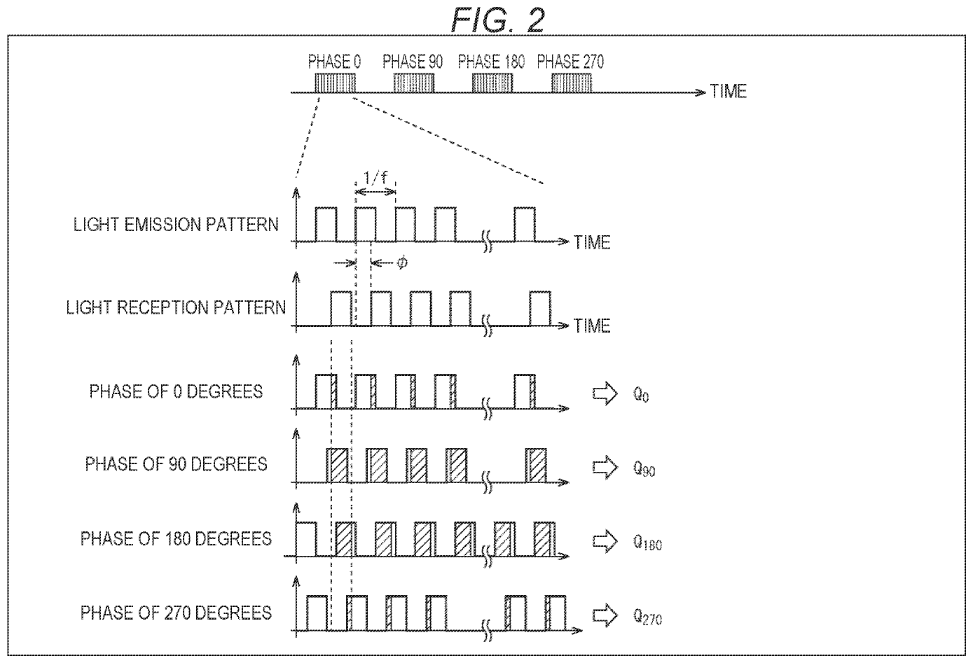

Before specific processing of the present disclosure is described, a distance measurement principle of the indirect ToF method will be briefly described with reference to FIG. 2.

A depth value d [mm] corresponding to the distance from the distance measurement module 11 to the object 21 can be calculated by the following expression (1).

[Expression 1]

d=½·c·Δt (1)

In the expression (1), Δt is a time until the irradiation light emitted from the light emitting unit 12 is reflected by the object 21 and is incident on the light receiving unit 15, and c represents the speed of light.

As the irradiation light emitted from the light emitting unit 12, as illustrated in FIG. 2, pulsed light is adopted of a light emission pattern that repeatedly turns on and off at a high speed at a predetermined frequency f (modulation frequency). One cycle T of the light emission pattern is 1/f. In the light receiving unit 15, the phase of the reflected light (light reception pattern) is detected to be shifted depending on the time Δt until the irradiation light reaches the light receiving unit 15 from the light emitting unit 12. When an amount of shift of the phase (phase difference) between the light emission pattern and the light reception pattern is φ, the time Δt can be calculated by the following expression (2).

$$Δ t = \frac{1}{f} \cdot \frac{ϕ}{2 π} \qquad ( 2 )$$

Thus, the depth value d from the distance measurement module 11 to the object 21 can be calculated by the following expression (3) from the expressions (1) and (2).

$$d = \frac{c ϕ}{4 π f} \qquad ( 3 )$$

Next, a method for calculating the above-described phase difference φ will be described.

Each pixel of the pixel array formed in the light receiving unit 15 repeats ON/OFF at a high speed and accumulates charges only during ON periods.

The light receiving unit 15 sequentially switches an execution timing of ON/OFF of each pixel of the pixel array, accumulates charges at each execution timing, and outputs a detection signal depending on the accumulated charges.

There are four types of ON/OFF execution timings, for example, a phase of 0 degrees, a phase of 90 degrees, a phase of 180 degrees, and a phase of 270 degrees.

The execution timing of the phase of 0 degrees is a timing at which the ON timing (light reception timing) of each pixel of the pixel array is set to the phase of the pulsed light emitted by the light source of the light emitting unit 12, that is, the same phase as the light emission pattern.

The execution timing of the phase of 90 degrees is a timing at which the ON timing (light reception timing) of each pixel of the pixel array is delayed by 90 degrees from the pulsed light (light emission pattern) emitted by the light source of the light emitting unit 12.

The execution timing of the phase of 180 degrees is a timing at which the ON timing (light reception timing) of each pixel of the pixel array is delayed by 180 degrees from the pulsed light (light emission pattern) emitted by the light source of the light emitting unit 12.

The execution timing of the phase of 270 degrees is a timing at which the ON timing (light reception timing) of each pixel of the pixel array is delayed by 270 degrees from the pulsed light (light emission pattern) emitted by the light source of the light emitting unit 12.

The light receiving unit 15 sequentially switches the light reception timings in the order of, for example, the phase of 0 degrees, the phase of 90 degrees, the phase of 180 degrees, and the phase of 270 degrees, and acquires the amount of received light of the reflected light (accumulated charge) at each light reception timing. In FIG. 2, at the light reception timing (ON timing) of each phase, the timing at which the reflected light is incident is shaded.

As illustrated in FIG. 2, assuming that Q₀, Q₉₀, Q₁₈₀, and Q₂₇₀ are charges accumulated when the light reception timing is set to the phase of 0 degrees, the phase of 90 degrees, the phase of 180 degrees, and the phase of 270 degrees, respectively, the phase difference φ can be calculated by the following expression (4) using Q₀, Q₉₀, Q₁₈₀, and Q₂₇₀.

$$ϕ = Arctan \frac{{Q}_{90} - {Q}_{270}}{{Q}_{180} - {Q}_{0}} \qquad ( 4 )$$

The depth value d from the distance measurement module 11 to the object 21 can be calculated by inputting the phase difference φ calculated by the expression (4) to the expression (3) described above.

Furthermore, a degree of confidence conf is a value representing an intensity of light received by each pixel, and can be calculated by, for example, the following expression (5).

[Expression 5]

conf=\sqrt{(Q₁₈₀−Q₀)²+(Q₉₀−Q₂₇₀)²} (5)

In each pixel of the pixel array, the light receiving unit 15 sequentially switches the light reception timing to the phase of 0 degrees, the phase of 90 degrees, the phase of 180 degrees, and the phase of 270 degrees as described above, and sequentially supplies the detection signal corresponding to the accumulated charge (charge Q₀, charge Q₉₀, charge Q₁₈₀, and charge Q₂₇₀) in each phase to the signal processing unit 16. Note that, by providing two charge accumulation units in each pixel of the pixel array and alternately accumulating charges in the two charge accumulation units, it is possible to acquire, in one frame, detection signals of two light reception timings whose phases are inverted from each other, as the phase of 0 degrees and the phase of 180 degrees, for example.

The signal processing unit 16 calculates the depth value d that is the distance from the distance measurement module 11 to the object 21 on the basis of the detection signal supplied from the light receiving unit 15 for each pixel of the pixel array. Then, a depth map in which the depth value d is stored as the pixel value of each pixel and a confidence map in which the degree of confidence conf is stored as the pixel value of each pixel are generated and output from the signal processing unit 16 to the outside of the module.

In an embedded device in which the distance measurement module 11 is incorporated, for example, the depth map output by the distance measurement module 11 is used to determine a distance for autofocus when a subject is imaged by a camera (image sensor).

The distance measurement sensor 14 outputs the depth map and the confidence map to a system (control unit) at the subsequent stage of the distance measurement module 11, and in addition, the system at the subsequent stage has a function of outputting additional information together useful for processing using the depth map and the confidence map.

Hereinafter, a detailed description will be given of a function of the distance measurement sensor 14 outputting the additional information useful for the processing using the depth map and the confidence map in addition to the depth map and the confidence map.

<3. First Configuration Example of Distance Measurement Sensor>

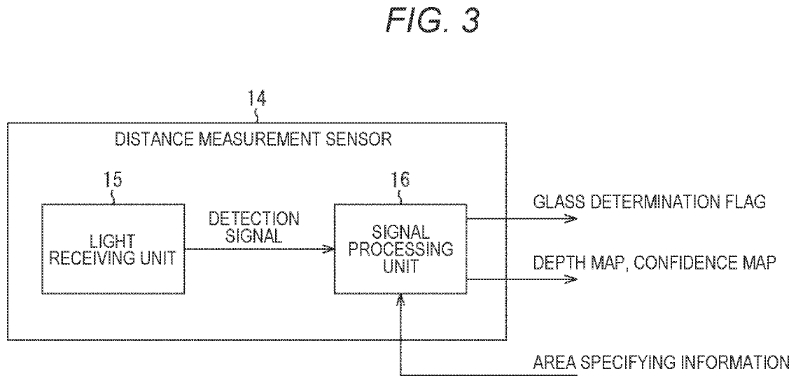

FIG. 3 is a block diagram illustrating a first configuration example of the distance measurement sensor 14.

In the first configuration example of FIG. 3, the distance measurement sensor 14 has a function of outputting a glass determination flag as the additional information.

For example, a case is assumed where a user images a landscape through glass with a camera of an embedded device in which the distance measurement module 11 is incorporated. A control unit of the embedded device (for example, a smartphone) gives an instruction of distance measurement to the distance measurement module 11, and the distance measurement module 11 measures a distance by emitting irradiation light on the basis of the instruction and outputs a depth map and a confidence map. At this time, in a case where there is glass between the distance measurement module 11 and a subject that is an original imaging target, the distance measurement module 11 measures a distance to a glass surface, not the subject as the imaging target. As a result, a situation occurs in which the image sensor cannot focus on the original imaging target.

Thus, the distance measurement sensor 14 according to the first configuration example outputs the glass determination flag representing whether the measurement result is a result of measuring the distance to the glass, as the additional information, together with the depth map and the confidence map. Note that, the glass determination flag is a flag representing a result of determining whether or not the object to be measured is a transparent object, and the object to be measured is not limited to glass, but a description will be given as glass determination processing to facilitate understanding.

As illustrated in FIG. 3, the signal processing unit 16 outputs the glass determination flag together with the depth map and the confidence map to the system at the subsequent stage. The glass determination flag is represented by, for example, “0” or “1”, where “1” represents that the object to be measured is glass, and “0” represents that the object to be measured is not glass.

Furthermore, there is a case where area specifying information that specifies a detection target area corresponding to a focus window for autofocus is supplied from a system at the subsequent stage to the signal processing unit 16. In a case where the area specifying information is supplied, the signal processing unit 16 limits the determination target area for determining whether or not the object to be measured is glass to an area indicated by the area specifying information. That is, the signal processing unit 16 outputs whether or not the measurement result of the area indicated by the area specifying information is a result of measuring glass, by the glass determination flag.

Specifically, first, the signal processing unit 16 calculates a glass determination parameter PARA1 by either of the following expressions (6) or (7).

$$PARA 1 = \frac{Max ( conf )}{Ave ( conf )} \qquad ( 6 )$$

$$PARA 1 = \frac{Max ( conf )}{Large\_Nth ( conf )} \qquad ( 7 )$$

In the expression (6), a value obtained by dividing a maximum value (area maximum value) of the degrees of confidence conf of all the pixels in the determination target area by an average value (area average value) of the degrees of confidence conf of all the pixels in the determination target area is set as the glass determination parameter PARA1. In the expression (7), a value obtained by dividing the maximum value of the degrees of confidence conf of all the pixels in the determination target area by the Nth degree of confidence conf from the largest among the degrees of confidence conf of all the pixels in the determination target area is set as the glass determination parameter PARA1. Max( ) represents a function of calculating the maximum value, Ave( ) represents a function of calculating the average value, and Large_Nth( ) represents a function of extracting the Nth (N>1) value from the largest. A value of N is determined in advance by initial setting or the like. The determination target area is the area indicated by the area specifying information in a case where the area specifying information is supplied from the system at the subsequent stage, and is the entire pixel area of the pixel array of the light receiving unit 15 in a case where the area specifying information is not supplied.

Then, as expressed by the expression (8), the signal processing unit 16 sets a glass determination flag glass_flg to “1” in a case where the glass determination parameter PARA1 is greater than a glass determination threshold value GL_Th determined in advance, sets the glass determination flag glass_flg to “0” in a case where the glass determination parameter PARA1 is less than or equal to the glass determination threshold value GL_Th, and outputs the glass determination flag glass_flg.

$$\begin{matrix}[ Expression 7 ] & \\ glass\_flg = \{ \begin{matrix}1 & ( PARA 1 > GL\_Th ) \\ 0 & ( PARA 1 ≦ GL\_Th )\end{matrix} & ( 8 )\end{matrix}$$

In a case where there is glass between the object to be measured and the distance measurement module 11, the irradiation light is reflected by the glass, so that the amount of received light is increased only in a portion due to intense reflected light and, in an area other than the portion, is the degree of confidence conf of the subject behind the glass, and the amount of received light (degree of confidence conf) is dark in the entire area. For that reason, by analyzing a ratio between the area maximum value and the area average value as in the expression (6), it is possible to determine whether or not the measurement result is a result of measuring glass. Furthermore, in the expression (7), in a case where glass exists, only the glass portion is an area (corresponding to a Max value) in which intense reflection occur, and thus, an area other than the portion is extracted as the Nth degree of confidence conf, and it is determined whether the area maximum value is a value obtained by measuring glass, by the magnitude of the ratio between a maximum value area and an area other than the maximum value area.

Note that, in the expression (8), the determination is made using the same glass determination threshold value GL_Th in both of a case where the glass determination parameter PARA1 according to the expression (6) is adopted and a case where the glass determination parameter PARA1 according to the expression (7) is adopted; however, the glass determination threshold value GL_Th may be set to different values between the glass determination parameter PARA1 according to the expression (6) and the glass determination parameter PARA1 according to the expression (7).

Furthermore, whether or not it is the glass may be determined by using both the glass determination parameter PARA1 according to the expression (6) and the glass determination parameter PARA1 according to the expression (7). In this case, the glass determination flag glass_flg is set to “1” in a case where it is determined as the glass by both the glass determination parameter PARA1 according to the expression (6) and the glass determination parameter PARA1 according to the expression (7).

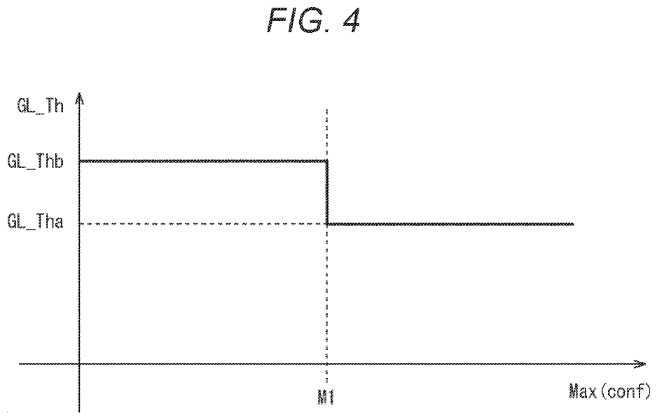

Furthermore, as illustrated in FIG. 4, the glass determination threshold value GL_Th may be set to a different value depending on the magnitude of the area maximum value. In the example of FIG. 4, the glass determination threshold value GL_Th is divided into two values depending on the magnitude of the area maximum value. In a case where the area maximum value is greater than a value M1, the determination of the expression (8) is executed using a glass determination threshold value GL_Tha, and in a case where the area maximum value is less than or equal to the value M1, the determination of the expression (8) is executed using the glass determination threshold value GL_Thb greater than the glass determination threshold value GL_Tha.

Note that, although not illustrated, the glass determination threshold value GL_Th may be set to different values in three or more levels instead of two levels.

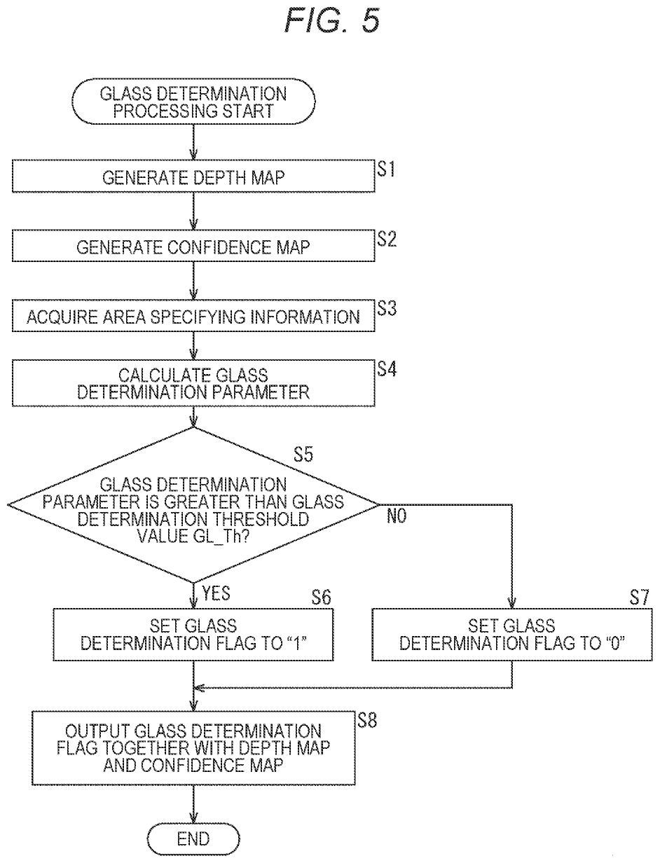

Glass determination processing by the signal processing unit 16 of the distance measurement sensor 14 according to the first configuration example will be described with reference to a flowchart of FIG. 5. This processing is started, for example, when the detection signal is supplied from the pixel array of the light receiving unit 15.

First, in step S1, the signal processing unit 16 calculates the depth value d that is a distance to the object to be measured for each pixel on the basis of the detection signal supplied from the light receiving unit 15. Then, the signal processing unit 16 generates the depth map in which the depth value d is stored as the pixel value of each pixel.

In step S2, the signal processing unit 16 calculates the degree of confidence conf for each pixel of each pixel, and generates the confidence map in which the degree of confidence conf is stored as the pixel value of each pixel.

In step S3, the signal processing unit 16 acquires the area specifying information that specifies the detection target area supplied from the system at the subsequent stage. In a case where the area specifying information is not supplied, the processing of step S3 is omitted. In a case where the area specifying information is supplied, the area indicated by the area specifying information is set as the determination target area for determining whether or not the object to be measured is glass. On the other hand, in a case where the area specifying information is not supplied, the entire pixel area of the pixel array of the light receiving unit 15 is set as the determination target area for determining whether or not the object to be measured is glass.

In step S4, the signal processing unit 16 calculates the glass determination parameter PARA1 by using either of the above-described expression (6) or (7).

In a case where the expression (6) is adopted, the signal processing unit 16 detects the maximum value (area maximum value) of the degrees of confidence conf of all the pixels in the determination target area. Furthermore, the signal processing unit 16 calculates the average value (area average value) of the degrees of confidence conf of all the pixels in the determination target area. Then, the signal processing unit 16 divides the area maximum value by the area average value to calculate the glass determination parameter PARA1.

In a case where the expression (7) is adopted, the signal processing unit 16 detects the maximum value (area maximum value) of the degrees of confidence conf of all the pixels in the determination target area. Furthermore, the signal processing unit 16 sorts the degrees of confidence conf of all the pixels in the determination target area in descending order, and extracts the Nth (N>1) value from the largest. Then, the signal processing unit 16 divides the area maximum value by the Nth value to calculate the glass determination parameter PARA1.

In step S5, the signal processing unit 16 determines whether the calculated glass determination parameter PARA1 is greater than the glass determination threshold value GL_Th.

In a case where it is determined in step S5 that the glass determination parameter PARA1 is greater than the glass determination threshold value GL_Th, the processing proceeds to step S6, and the signal processing unit 16 sets the glass determination flag glass_flg to “1”.

On the other hand, in a case where it is determined in step S5 that the glass determination parameter PARA1 is less than or equal to the glass determination threshold value GL_Th, the processing proceeds to step S7, and the signal processing unit 16 sets the glass determination flag glass_flg to “0”.

Then, in step S8, the signal processing unit 16 outputs the glass determination flag glass_flg to the system at the subsequent stage together with the depth map and the confidence map, and ends the processing.

As described above, with the distance measurement sensor 14 according to the first configuration example, when the depth map and the confidence map are output to the system at the subsequent stage, the glass determination flag can be output that determines whether or not the object to be measured is glass.

As a result, the system at the subsequent stage that has acquired the depth map and the confidence map can recognize that there is a possibility that the distance measurement result by the distance measurement module 11 is not a value obtained by measuring a distance to the original imaging target. In this case, for example, the system at the subsequent stage can perform control such as switching the focus control to autofocus of a contrast method without using the distance information of the depth map acquired.

<4. Second Configuration Example of Distance Measurement Sensor>

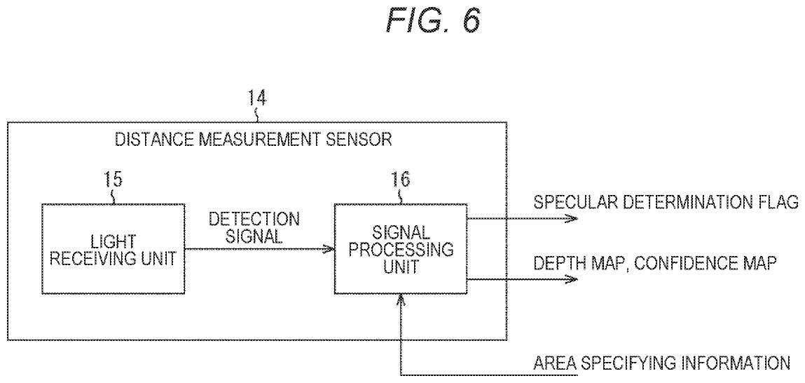

FIG. 6 is a block diagram illustrating a second configuration example of the distance measurement sensor 14.

In the second configuration example of FIG. 6, the distance measurement sensor 14 has a function of outputting a specular determination flag as additional information.

In the ToF method, the light is emitted and the reflected light reflected from the object is received to calculate the distance, so that when an object having a high reflectance, for example, a mirror, an iron door, or the like (hereinafter, referred to as a specular reflector) is measured, there has been a case where a measurement distance is inaccurate, for example, the distance is calculated as a distance longer than the actual distance due to multiple reflections on the surface of the specular reflector.

Thus, the distance measurement sensor 14 according to the second configuration example outputs the specular determination flag representing whether the measurement result is a result of measuring the specular reflector, as the additional information, together with the depth map and the confidence map.

Note that, in the first configuration example described above, one glass determination flag is output for one depth map or the detection target area specified by the area specifying information in the depth map, but the distance measurement sensor 14 of the second configuration example outputs the specular determination flag in units of pixels.

Specifically, the signal processing unit 16 first generates the depth map and the confidence map.

Next, the signal processing unit 16 calculates a reflectance ref of the object to be measured for each pixel. The reflectance ref is expressed by the expression (9), and is calculated by multiplying the square of the depth value d [mm] by the degree of confidence conf.

ref=conf×(d/1000)² (9)

Next, the signal processing unit 16 extracts one or more pixels of which the reflectance ref is greater than a first reflection threshold value RF_Th1 and the depth value d is within 1000 [mm], as an area where there is a possibility that the specular reflector is measured (hereinafter, referred to as a specular reflectance possibility area).

In a case where the irradiation light is reflected by the specular reflector, an amount of reflected light is extremely large. Thus, first, a condition that the reflectance ref is greater than the first reflection threshold value RF_Th1 is set as a condition of the specular reflectance possibility area.

Furthermore, a phenomenon in which the measurement distance is inaccurate due to the specular reflector is mainly limited to a case where the specular reflector exists at a certain short distance. For that reason, a condition that the calculated depth value d is the certain short distance is set as a condition of the specular reflectance possibility area. Note that, 1000 [mm] is merely an example, and the depth value d set as the short distance can be appropriately set.

Next, the signal processing unit 16 determines whether the depth value d of each pixel is a value obtained by measuring the specular reflector, by a determination expression of the following expression (10), and sets and outputs a specular determination flag specular_flg.

$$[ Expression 8 ]$$

$$\{ \begin{matrix}case of RF\_TH1 < ref \leq RF\_TH2 \\ 1 if ref < conf\_Th1 \\ 0 otherwise \\ case of RF\_Th2 < ref \\ 1 if ref < conf\_Th1 \\ 0 otherwise \\ where \\ conf\_Th1 = \\ \{ conf\_L1 + ( ref - RF\_TH1 ) \times \frac{( conf\_L2 = conf\_L1}{( RF\_TH2 - RF\_TH1 )} \} \\ conf\_TH2 = conf\_L2\end{matrix} \qquad ( 10 )$$

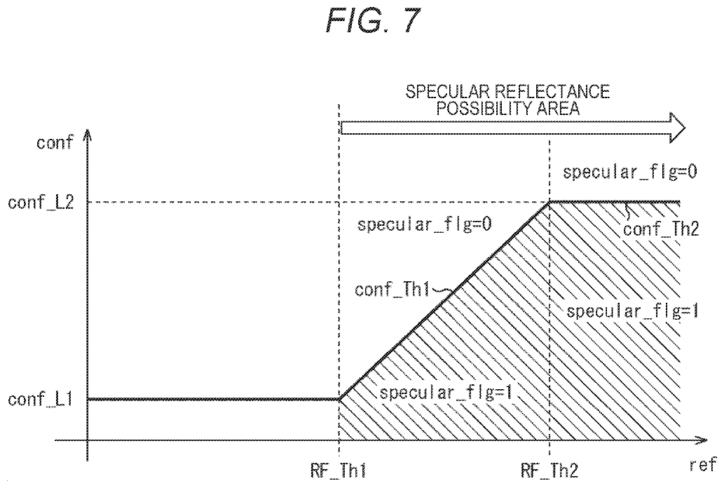

When represented in the figure, the determination expression of the expression (10) is expressed as FIG. 7.

As described above, the specular reflectance possibility area is limited to the pixel in which the reflectance ref is greater than the first reflection threshold value RF_Th1.

The determination expression of the specular determination flag is divided into a case where the reflectance ref of the pixel is greater than the first reflection threshold value RF_Th1 and less than or equal to a second reflection threshold value RF_Th2, and a case where the reflectance ref is greater than the second reflection threshold value RF_Th2.

In the case where the reflectance ref of the pixel is greater than the first reflection threshold value RF_Th1 and less than or equal to the second reflection threshold value RF_Th2, in a case where the degree of confidence conf of the pixel is less than a first confidence threshold value conf_Th1, it is determined that the object to be measured is a specular reflector and “1” is set to the specular determination flag specular_flg. On the other hand, in a case where the degree of confidence conf of the pixel is greater than or equal to the first confidence threshold value conf_Th1, it is determined that the object to be measured is not the specular reflector, and “0” is set to the specular determination flag specular_flg.

Here, as illustrated in FIG. 7, the first confidence threshold value conf_Th1 is a value that is adaptively changed depending on the reflectance ref, from a degree of confidence conf_L1 at the first reflection threshold value RF_Th1 to a degree of confidence conf_L2 at the second reflection threshold value RF_Th2.

Next, in a case where the reflectance ref of the pixel is greater than the second reflection threshold value RF_Th2, in a case where the degree of confidence conf of the pixel is less than a second confidence threshold value conf_Th2, it is determined that the object to be measured is a specular reflector, and “1” is set to the specular determination flag specular_flg. On the other hand, in a case where the degree of confidence conf of the pixel is greater than or equal to the second confidence threshold value conf_Th2, it is determined that the object to be measured is not the specular reflector, and “0” is set to the specular determination flag specular_flg.

Here, as illustrated in FIG. 7, the second confidence threshold value conf_Th2 is a value equal to the degree of confidence conf_L2.

According to the determination expression of the expression (10), it is determined that the depth value d of the pixel having the reflectance ref and the degree of confidence conf corresponding to the area indicated by hatching in the specular reflectance possibility area illustrated in FIG. 7 is obtained by measuring the specular reflector as the object to be measured and there is a possibility that the measurement distance is inaccurate, and the specular determination flag specular_flg=“1” is output.

According to the determination expression of the expression (10), with respect to the pixel in the specular reflectance possibility area, in a case where the reflectance ref is high and the degree of confidence conf is less than or equal to a certain reference, the specular determination flag specular_flg=“1” is set. Then, in a case of a normal measurement result, if the reflectance ref is large, the degree of confidence conf should also be large, and thus, the reference of the degree of confidence conf is changed to be large depending on the reflectance ref.

Note that, similarly to the first configuration example described above, the area specifying information may be supplied from the system at the subsequent stage to the signal processing unit 16. In this case, the signal processing unit 16 limits a determination target area for determining whether or not the object to be measured is the specular reflector to the area indicated by the area specifying information. That is, the signal processing unit 16 determines whether or not the measurement result is a result of measuring the specular reflector only for the area indicated by the area specifying information, and outputs the specular determination flag.

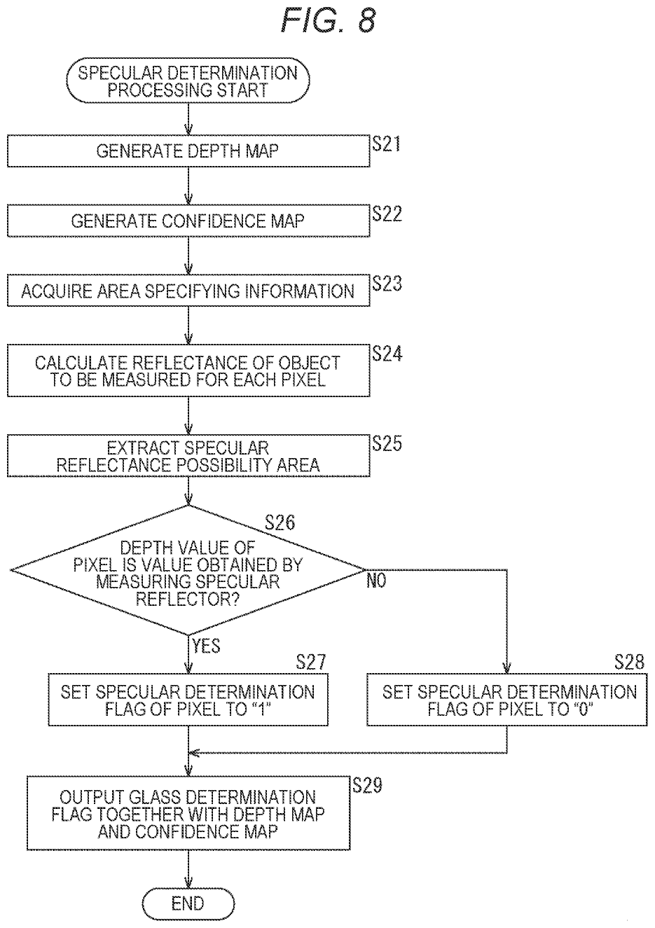

Specular determination processing by the signal processing unit 16 of the distance measurement sensor 14 according to the second configuration example will be described with reference to a flowchart of FIG. 8. This processing is started, for example, when the detection signal is supplied from the pixel array of the light receiving unit 15.

First, in step S21, the signal processing unit 16 calculates the depth value d that is the distance to the object to be measured for each pixel on the basis of the detection signal supplied from the light receiving unit 15. Then, the signal processing unit 16 generates the depth map in which the depth value d is stored as the pixel value of each pixel.

In step S22, the signal processing unit 16 calculates the degree of confidence conf for each pixel of each pixel, and generates the confidence map in which the degree of confidence conf is stored as the pixel value of each pixel.

In step S23, the signal processing unit 16 acquires the area specifying information that specifies the detection target area supplied from the system at the subsequent stage. In a case where the area specifying information is not supplied, the processing of step S23 is omitted. In a case where the area specifying information is supplied, the area indicated by the area specifying information is set as the determination target area for determining whether or not the object to be measured is the specular reflector. On the other hand, in a case where the area specifying information is not supplied, the entire pixel area of the pixel array of the light receiving unit 15 is set as the determination target area for determining whether or not the object to be measured is the specular reflector.

In step S24, the signal processing unit 16 calculates the reflectance ref of the object to be measured for each pixel by using the above-described expression (9).

In step S25, the signal processing unit 16 extracts the specular reflectance possibility area. That is, the signal processing unit 16 extracts one or more pixels in which the reflectance ref is greater than the first reflection threshold value RF_Th1 and the depth value d is within 1000 [mm] in the determination target area, and sets the pixels as the specular reflectance possibility area.

In step S26, the signal processing unit 16 determines, for each pixel in the determination target area, whether the depth value d of the pixel is a value obtained by measuring the specular reflector, by the determination expression of the expression (10).

In a case where it is determined in step S26 that the depth value d of the pixel is a value obtained by measuring the specular reflector, the processing proceeds to step S27, and the signal processing unit 16 sets the specular determination flag specular_flg of the pixel to “1”.

On the other hand, in a case where it is determined in step S26 that the depth value d of the pixel is not a value obtained by measuring the specular reflector, the processing proceeds to step S28, and the signal processing unit 16 sets the specular determination flag specular_flg to “0”.

The processing of step S26, and the processing of step S27 or S28 based on the determination result are executed for all the pixels in the determination target area.

Then, in step S29, the signal processing unit 16 outputs the specular determination flag specular_flg set to each pixel to the system at the subsequent stage together with the depth map and the confidence map, and ends the processing.

As described above, with the distance measurement sensor 14 according to the second configuration example, when the depth map and the confidence map are output to the system at the subsequent stage, the specular determination flag can be output that determines whether or not the object to be measured is the specular reflector. The specular determination flag can be output as mapping data in which the specular determination flag is stored as a pixel value of each pixel, such as the depth map or the confidence map.

As a result, the system at the subsequent stage that has acquired the depth map and the confidence map can recognize that there is a possibility that the distance measurement result by the distance measurement module 11 is not a value obtained by accurately measuring the distance to the imaging target. In this case, for example, the system at the subsequent stage can perform control such as switching the focus control to autofocus of a contrast method without using the distance information of the depth map acquired.

Note that, in the above-described example, the specular determination flag is output in units of pixels; however, similarly to the first configuration example, one specular determination flag may be output for (a detection target area of) one depth map. In this case, for example, the signal processing unit 16 detects a pixel having the maximum reflectance ref among one or more pixels in the determination target area. Then, the signal processing unit 16 can output the specular determination flag in units of one depth map by performing the determination of the expression (10) using the degree of confidence conf of the pixel having the maximum reflectance ref.

<5. Third Configuration Example of Distance Measurement Sensor>

Next, a third configuration example of the distance measurement sensor 14 will be described.

In the distance measurement sensor, for example, a measurement error of about several cm may occur, and correction of about several cm may be performed in calibration processing. In this case, for example, in a case where the modulation frequency of the light emitting source is 20 MHz, the maximum measurement range is 7.5 m, and correction of several cm at a measurement distance of 1 m to several m does not cause a large problem, but a problem may occur at a very short distance of, for example, 10 cm or less.

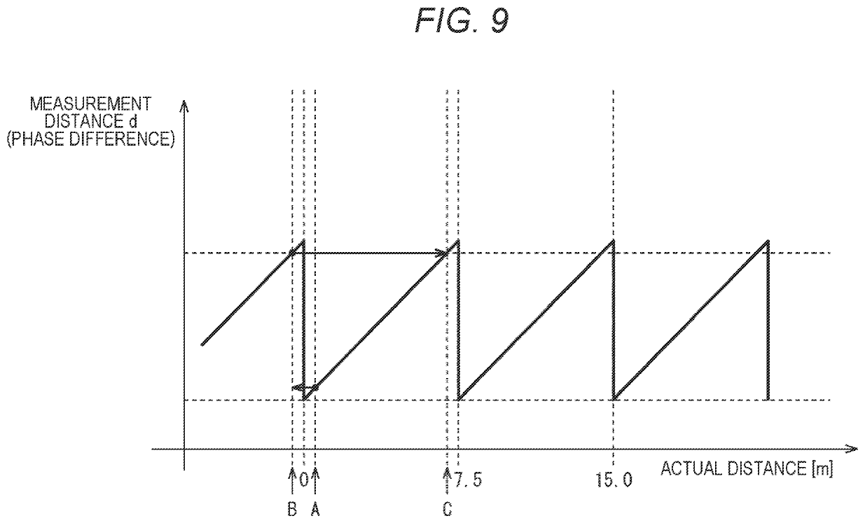

With reference to FIG. 9, a problem will be described that can occur in the very short distance.

In the distance measurement sensor of the indirect ToF method, since the phase difference is detected and converted into the distance, the maximum measurement range is determined depending on the modulation frequency of the light emitting source, and when the maximum measurement distance is exceeded, the detected phase difference starts from zero again. For example, in a case where the modulation frequency of the light source is 20 MHz, as illustrated in FIG. 9, the maximum measurement range is 7.5 m, and the phase difference periodically changes in units of 7.5 m.

For example, in the distance measurement sensor, it is assumed that the calibration processing is incorporated to perform correction of −5 cm on the measured value of the sensor. Here, in a case where a distance of 3 cm indicated by an arrow A in FIG. 9 is measured, the actual distance is 3−5=−2 cm in a case where −5 cm is corrected, and the measurement result is a negative value indicated by an arrow B.

Since the measurement result cannot have a negative value (−2 cm), the distance measurement sensor outputs a distance indicated by a corresponding phase difference in the measurement range, specifically, 7.48 m=(7.5 m−2 cm) indicated by an arrow C, which is obtained by folding back to the maximum measurement distance side. As described above, there is a case where an incorrect measurement result is output in a case where a negative value is obtained by the calibration processing (case 1).

Furthermore, for example, in a case where the measured value of the distance measurement sensor is obtained as 6 cm, an output value after the calibration processing is 6−5=1 cm by performing correction of −5 cm, but it is determined that the amount of light is small (the degree of confidence conf is small) for a distance of 1 cm (since it is actually 6 cm). As a result, there is a case where an output is performed as a measurement error, as the pixel having the low degree of confidence conf (case 2).

For such problems of the case 1 and the case 2, it may be preferable to notify that the distance information is a very short distance even if the distance information is not accurate for the system at the subsequent stage that acquires the distance information.

Thus, the third configuration example of the distance measurement sensor 14 is configured to be able to output information indicating that the distance to the object to be measured is a very short distance in which the above-described cases 1 and 2 occur.

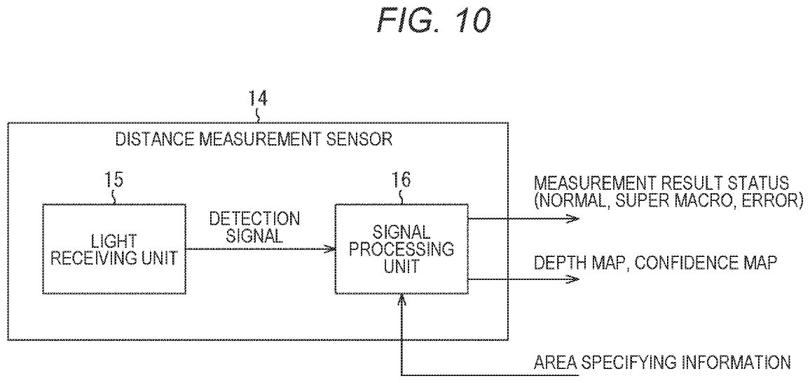

FIG. 10 is a block diagram illustrating the third configuration example of the distance measurement sensor 14.

In the third configuration example of FIG. 10, the distance measurement sensor 14 has a function of outputting information indicating that it is a very short distance as a measurement status.

The distance measurement sensor 14 according to the third configuration example outputs a status of the measurement result (measurement result status) as additional information together with the depth map and the confidence map.

The measurement result status includes a normal flag, a super macro flag, and an error flag. The normal flag represents that the output measured value is a normal measurement result. The super macro flag represents that the object to be measured is at a very short distance, and the output measured value is an inaccurate measurement result. The error flag represents that the object to be measured is in a very short distance and the measured value cannot be output.

In the present embodiment, the very short distance is a distance at which a phenomenon such as the case 1 or the case 2 described above occurs in a case where correction of about several cm is performed by the calibration processing, and for example, can be set to a distance to the object as the object to be measured of up to about 10 cm. A distance range to the object to be measured for which the super macro flag is set (distance range determined to be a very short distance) can be set in accordance with, for example, a distance range in which the system at the subsequent stage uses a lens for the very short distance. Alternatively, the distance range to the object to be measured for which the super macro flag is set can be set to a distance at which an influence on the reflectance ref due to the measurement error of the distance measurement sensor 14 (change in the reflectance ref due to the measurement error) exceeds N times (N>1), and N can be set to 2 (that is, a distance at which the influence exceeds two times), for example.

The measurement result status can be output for each pixel. Note that, the measurement result status does not have to be output in a case where the status corresponds to the normal flag, and may be output only in a case of either the super macro flag or the error flag.

Note that, similarly to the first configuration example and the second configuration example described above, there is a case where the area specifying information is supplied from the system at the subsequent stage to the signal processing unit 16. In this case, the signal processing unit 16 may output the measurement result status to only a limited area indicated by the area specifying information.

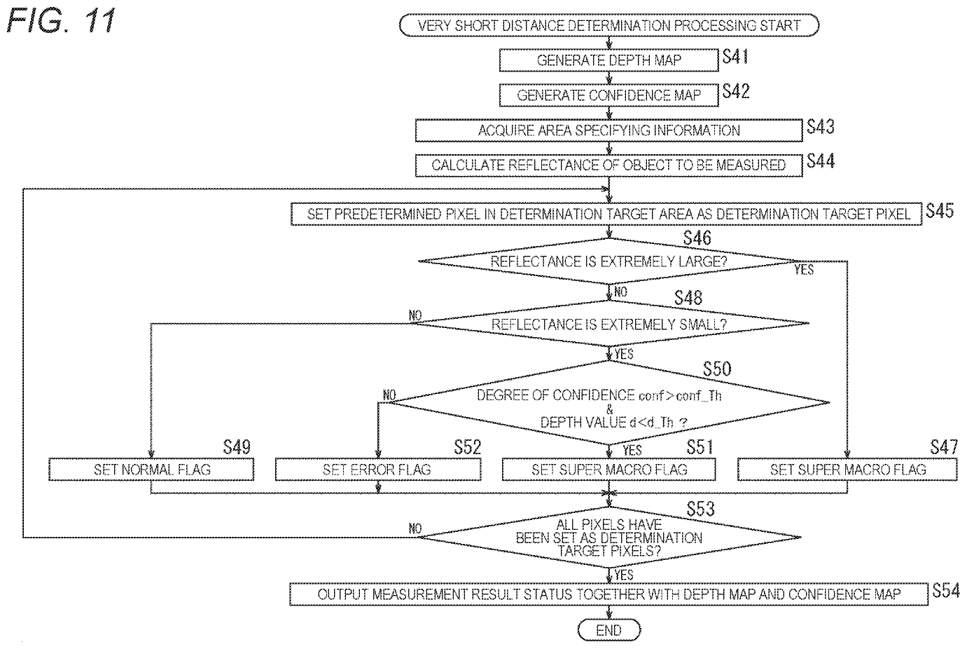

With reference to the flowchart of FIG. 11, a description will be given of very short distance determination processing by the signal processing unit 16 of the distance measurement sensor 14 according to the third configuration example. This processing is started, for example, when the detection signal is supplied from the pixel array of the light receiving unit 15.

First, in step S41, the signal processing unit 16 calculates the depth value d that is the distance to the object to be measured for each pixel on the basis of the detection signal supplied from the light receiving unit 15. Then, the signal processing unit 16 generates the depth map in which the depth value d is stored as the pixel value of each pixel.

In step S42, the signal processing unit 16 calculates the degree of confidence conf for each pixel of each pixel, and generates the confidence map in which the degree of confidence conf is stored as the pixel value of each pixel.

In step S43, the signal processing unit 16 acquires the area specifying information that specifies the detection target area supplied from the system at the subsequent stage. In a case where the area specifying information is not supplied, the processing of step S43 is omitted. In a case where the area specifying information is supplied, the area indicated by the area specifying information is set as a determination target area for determining the measurement result status. On the other hand, in a case where the area specifying information is not supplied, the entire pixel area of the pixel array of the light receiving unit 15 is set as the determination target area for determining the measurement result status.

In step S44, the signal processing unit 16 calculates the reflectance ref of the object to be measured for each pixel by using the above-described expression (9).

In step S45, the signal processing unit 16 sets a predetermined pixel in the determination target area as a determination target pixel.

In step S46, the signal processing unit 16 determines whether the reflectance ref of the determination target pixel is extremely large, specifically, whether the reflectance ref of the determination target pixel is greater than a reflection threshold value RFmax_Th determined in advance.

In a case where it is determined in step S46 that the reflectance ref of the determination target pixel is extremely large, in other words, the reflectance ref of the determination target pixel is greater than the reflection threshold value RFmax_Th, the processing proceeds to step S47, and the signal processing unit 16 sets the super macro flag as the measurement result status of the determination target pixel. The reflection threshold value RFmax_Th is set on the basis of, for example, a result of measurement at a very short distance in pre-shipment inspection.

A pixel for which “YES” is determined in the processing of step S46 and the super macro flag is set corresponds to a case where the measured value is a very short distance and an inaccurate measurement result is output, such as a case where the measured value of the sensor after the calibration processing is a negative value as in the case 1 described above. After the processing of step S47, the processing proceeds to step S53.

On the other hand, in a case where it is determined that the reflectance ref of the determination target pixel is not extremely large, in other words, in a case where it is determined that the reflectance ref of the determination target pixel is less than or equal to the reflection threshold value RFmax_Th, the processing proceeds to step S48, and the signal processing unit 16 determines whether the reflectance ref of the determination target pixel is extremely small.

In step S48, in a case where the reflectance ref of the determination target pixel is less than a reflection threshold value RFmin_Th determined in advance, it is determined that the reflectance ref of the determination target pixel is extremely small. The reflection threshold value RFmin_Th (<RFmax_Th) is also set on the basis of, for example, the result of measurement at the very short distance in the pre-shipment inspection.

In a case where it is determined in step S48 that the reflectance ref of the determination target pixel is not extremely small, in other words, the reflectance ref of the determination target pixel is greater than or equal to the reflection threshold value RFmin_Th, the processing proceeds to step S49, and the signal processing unit 16 sets the normal flag as the measurement result status of the determination target pixel. After the processing of step S49, the processing proceeds to step S53.

On the other hand, in a case where it is determined in step S48 that the reflectance ref of the determination target pixel is extremely small, the processing proceeds to step S50, and the signal processing unit 16 determines whether the degree of confidence conf of the determination target pixel is greater than a predetermined threshold value conf_Th and the depth value d of the determination target pixel is less than a predetermined threshold value d_Th.

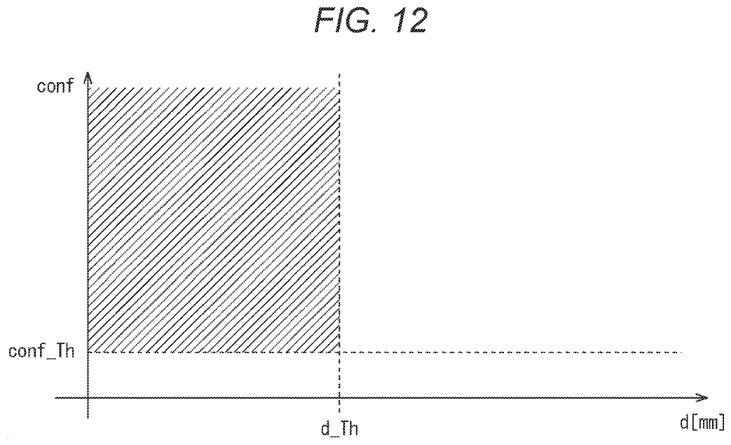

FIG. 12 is a graph illustrating a relationship between the degree of confidence conf and the depth value d of the determination target pixel.

In a case where it is determined that the degree of confidence conf of the determination target pixel is greater than the predetermined threshold value conf_Th and the depth value d of the determination target pixel is less than the predetermined threshold value d_Th, the determination target pixel corresponds to the area indicated by hatching in FIG. 12.

In a case where it is determined that the reflectance ref of the determination target pixel is extremely small in the processing of step S48 described above, the processing proceeds to the processing of step S50, and thus, the determination target pixel on which the processing of step S50 is performed is basically a pixel having extremely small reflectance ref. In the graph of FIG. 12, the determination target pixel corresponds to a pixel for which it is determined that the depth value d is less than the predetermined threshold value d_Th.

Thus, in the processing of step S50, it is determined whether or not the degree of confidence conf of the determination target pixel is greater than the predetermined threshold value conf_Th, in other words, whether the depth value d represents a short distance and also the intensity of the reflected light has a magnitude corresponding to the short distance.

In a case where it is determined in step S50 that the degree of confidence conf of the determination target pixel is greater than the predetermined threshold value conf_Th and the depth value d of the determination target pixel is less than the predetermined threshold value d_Th, in other words, in a case where the depth value d represents a short distance and also the intensity of the reflected light has a magnitude corresponding to the short distance, the processing proceeds to step S51, and the signal processing unit 16 sets the super macro flag as the measurement result status of the determination target pixel.

A pixel for which “YES” is determined in the processing of step S50 and the super macro flag is set includes a case where the amount of light is small for the distance and an output is performed as a measurement error as in the case 2 described above. In other words, some of the pixels in which an output has been performed as a measurement error as in the case 2 are changed to output the measured value (depth value d) together with the super macro flag indicating that it is a very short distance, not the measurement error. After the processing of step S51, the processing proceeds to step S53.

On the other hand, in a case where it is determined in step S50 that the degree of confidence conf of the determination target pixel is less than or equal to the predetermined threshold value conf_Th or the depth value d of the determination target pixel is greater than or equal to the predetermined threshold value d_Th, the processing proceeds to step S52, and the signal processing unit 16 sets the error flag as the measurement result status of the determination target pixel. After the processing of step S52, the processing proceeds to step S53.

The processing in steps S51 and S52 corresponds to subdividing the problem in the case 2 described above, which occurs in a case where the object to be measured exists in a very short distance, into the measurement error (error flag) and the output of the measured value in the very short distance (super macro flag).

In step S53, the signal processing unit 16 determines whether all the pixels in the determination target area have been set as the determination target pixels.

In a case where it is determined in step S53 that all the pixels in the determination target area have not been set as the determination target pixels yet, the processing returns to step S45, and the processing of steps S45 to S53 described above is repeated. That is, a pixel that has not yet been set as the determination target pixel is set as the next determination target pixel, and processing is performed of setting the measurement result status of the normal flag, the super macro flag, or the error flag.

On the other hand, in a case where it is determined in step S53 that all the pixels in the determination target area have been set as the determination target pixels, the processing proceeds to step S54, and the signal processing unit 16 outputs the measurement result status set for each pixel to the system at the subsequent stage together with the depth map and the confidence map, and ends the processing. The measurement result status can be output as mapping data in which the measurement result status is stored as a pixel value of each pixel, such as a depth map or a confidence map.

As described above, with the distance measurement sensor 14 according to the third configuration example, the measurement result status set for each pixel can be output when the depth map and the confidence map are output to the system at the subsequent stage. The measurement result status includes information (super macro flag) indicating that the distance measurement result is a very short distance, information (error flag) indicating that the measurement is impossible due to the very short distance, and information (normal flag) indicating that the distance measurement result is a normal measurement result.

As a result, in a case where the pixel in which the super macro flag is set is included as the measurement result status, the system at the subsequent stage that has acquired the depth map and the confidence map can recognize that the object to be measured is in the very short distance and operate the system in a very short distance mode or the like. Furthermore, in a case where a pixel in which the error flag is set is included as the measurement result status, the system at the subsequent stage can perform control such as switching the focus control to autofocus of a contrast method.

<6. Fourth Configuration Example of Distance Measurement Sensor>

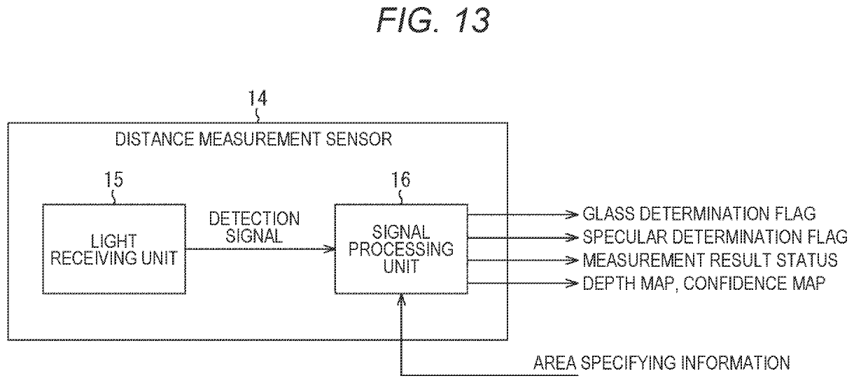

FIG. 13 is a block diagram illustrating a fourth configuration example of the distance measurement sensor 14.

The distance measurement sensor 14 according to the fourth configuration example has a configuration including all the functions of the first configuration example to the third configuration example described above.

That is, the signal processing unit 16 of the distance measurement sensor 14 according to the fourth configuration example has a function of outputting the depth map and the confidence map, a function of outputting the glass determination flag, a function of outputting the specular determination flag, and a function of outputting the measurement result status. Details of each function are similar to those of the first configuration example to the third configuration example described above, and thus the description thereof will be omitted.

The distance measurement sensor 14 according to the fourth configuration example may have a configuration in which not all the functions of the first configuration example to the third configuration example but two functions are appropriately combined. That is, the signal processing unit 16 may have the function of outputting the glass determination flag and the function of outputting the specular determination flag in addition to the function of outputting the depth map and the confidence map. Alternatively, the signal processing unit 16 may have the function of outputting the specular determination flag and the function of outputting the measurement result status in addition to the function of outputting the depth map and the confidence map. Alternatively, the signal processing unit 16 may have the function of outputting the glass determination flag and the function of outputting the measurement result status in addition to the function of outputting the depth map and the confidence map.

<7. Configuration Example of Electronic Device>

The above-described distance measurement module 11 can be mounted on, for example, an electronic device such as a smartphone, a tablet terminal, a mobile phone, a personal computer, a game machine, a television receiver, a wearable terminal, a digital still camera, or a digital video camera.

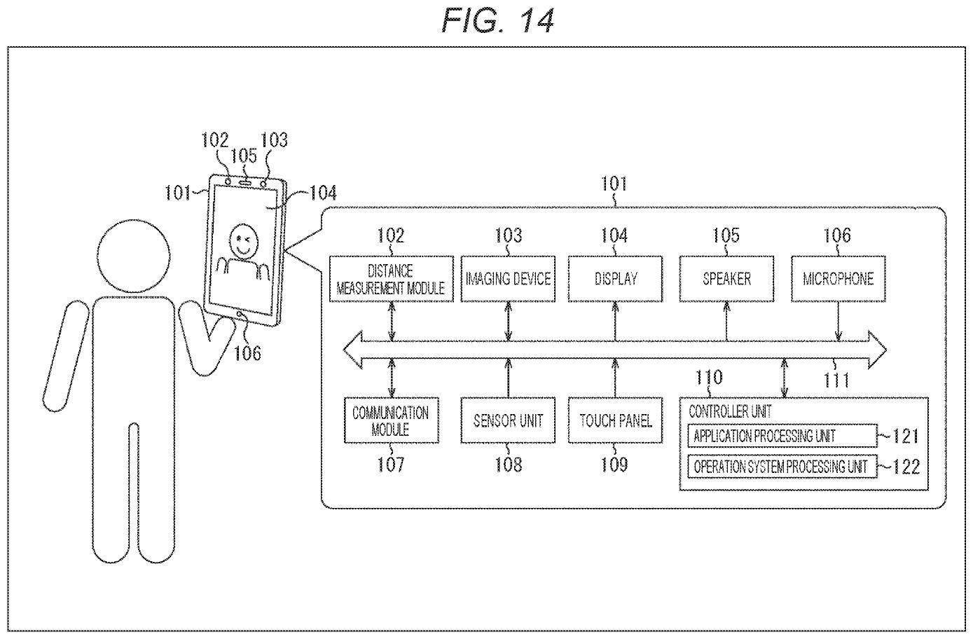

FIG. 14 is a block diagram illustrating a configuration example of a smartphone as an electronic device on which the distance measurement module is mounted.

As illustrated in FIG. 14, a smartphone 101 includes a distance measurement module 102, an imaging device 103, a display 104, a speaker 105, a microphone 106, a communication module 107, a sensor unit 108, a touch panel 109, and a controller unit 110 that are connected to each other via a bus 111. Furthermore, the controller unit 110 has functions as an application processing unit 121 and an operation system processing unit 122 by executing a program by a CPU.

The distance measurement module 11 of FIG. 1 is applied to the distance measurement module 102. For example, the distance measurement module 102 is arranged in the front surface of the smartphone 101 and performs distance measurement for a user of the smartphone 101, thereby being able to output depth values of the surface shapes of the user's face, hand, finger, and the like as distance measurement results.

The imaging device 103 is arranged in the front surface of the smartphone 101 and performs imaging of the user of the smartphone 101 as a subject, thereby acquiring an image of the user. Note that, although not illustrated, the imaging device 103 may be arranged on the back surface of the smartphone 101.

The display 104 displays an operation screen for performing processing by the application processing unit 121 and the operation system processing unit 122, an image captured by the imaging device 103, and the like. The speaker 105 and the microphone 106 output the voice of the other party and collect the voice of the user when a call is made with the smartphone 101, for example.

The communication module 107 performs communication via a communication network. The sensor unit 108 senses speed, acceleration, proximity, and the like, and the touch panel 109 acquires a user's touch operation on the operation screen displayed on the display 104.

The application processing unit 121 performs processing for providing various services by the smartphone 101. For example, the application processing unit 121 can perform processing of creating a face by computer graphics that virtually reproduces the user's facial expression on the basis of the depth value supplied from the distance measurement module 102, and displaying the face on the display 104. Furthermore, the application processing unit 121 can perform processing of creating, for example, three-dimensional shape data of any three-dimensional object on the basis of the depth value supplied from the distance measurement module 102.

The operation system processing unit 122 performs processing for implementing basic functions and operations of the smartphone 101. For example, the operation system processing unit 122 can perform processing of authenticating the user's face and unlocking the smartphone 101 on the basis of the depth value supplied from the distance measurement module 102. Furthermore, the operation system processing unit 122 can perform, for example, processing of recognizing the user's gesture on the basis of the depth value supplied from the distance measurement module 102, and performs processing of inputting various operations corresponding to the gesture.

In the smartphone 101 configured as described above, for example, the distance measurement information can be more accurately detected by applying the above-described distance measurement module 11. Furthermore, processing can be executed in which information such as a case where the object to be measured is a transparent object, a case where the object to be measured is a specular reflector, or a case where the object to be measured is at a very short distance is acquired as additional information and the information is reflected in imaging or the like by the imaging device 103.

<8. Application Example to Mobile Body>

The technology according to the present disclosure (the present technology) can be applied to various products. The technology according to the present disclosure may be implemented as a device mounted on any type of mobile body, for example, a car, an electric car, a hybrid electric car, a motorcycle, a bicycle, a personal mobility, an airplane, a drone, a ship, a robot, or the like.

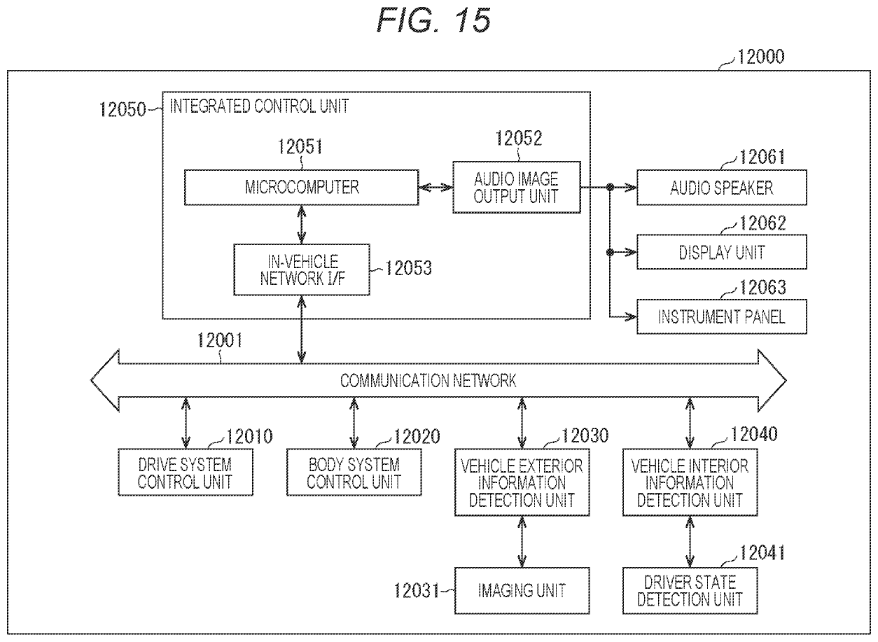

FIG. 15 is a block diagram illustrating a schematic configuration example of a vehicle control system that is an example of a mobile body control system to which the technology according to the present disclosure can be applied.

The vehicle control system 12000 includes a plurality of electronic control units connected to each other via a communication network 12001. In the example illustrated in FIG. 15, the vehicle control system 12000 includes a drive system control unit 12010, a body system control unit 12020, a vehicle exterior information detection unit 12030, a vehicle interior information detection unit 12040, and an integrated control unit 12050. Furthermore, as functional configurations of the integrated control unit 12050, a microcomputer 12051, an audio image output unit 12052, and an in-vehicle network interface (I/F) 12053 are illustrated.

The drive system control unit 12010 controls operation of devices related to a drive system of a vehicle in accordance with various programs. For example, the drive system control unit 12010 functions as a control device of a driving force generating device for generating driving force of the vehicle, such as an internal combustion engine or a driving motor, a driving force transmitting mechanism for transmitting driving force to wheels, a steering mechanism for adjusting a steering angle of the vehicle, a braking device for generating braking force of the vehicle, and the like.

The body system control unit 12020 controls operation of various devices equipped on the vehicle body in accordance with various programs. For example, the body system control unit 12020 functions as a control device of a keyless entry system, a smart key system, a power window device, or various lamps such as a head lamp, a back lamp, a brake lamp, a turn signal lamp, and a fog lamp. In this case, to the body system control unit 12020, a radio wave transmitted from a portable device that substitutes for a key, or signals of various switches can be input. The body system control unit 12020 accepts input of these radio waves or signals and controls a door lock device, power window device, lamp, and the like of the vehicle.

The vehicle exterior information detection unit 12030 detects information on the outside of the vehicle on which the vehicle control system 12000 is mounted. For example, an imaging unit 12031 is connected to the vehicle exterior information detection unit 12030. The vehicle exterior information detection unit 12030 causes the imaging unit 12031 to capture an image outside the vehicle and receives the image captured. The vehicle exterior information detection unit 12030 may perform object detection processing or distance detection processing on a person, a car, an obstacle, a sign, a character on a road surface, or the like, on the basis of the received image.

The imaging unit 12031 is an optical sensor that receives light and outputs an electric signal corresponding to an amount of received light. The imaging unit 12031 can output the electric signal as an image, or as distance measurement information. Furthermore, the light received by the imaging unit 12031 may be visible light, or invisible light such as infrared rays.

The vehicle interior information detection unit 12040 detects information on the inside of the vehicle. The vehicle interior information detection unit 12040 is connected to, for example, a driver state detecting unit 12041 that detects a state of a driver. The driver state detecting unit 12041 includes, for example, a camera that captures an image of the driver, and the vehicle interior information detection unit 12040 may calculate a degree of fatigue or a degree of concentration of the driver, or determine whether or not the driver is dozing, on the basis of the detection information input from the driver state detecting unit 12041.

The microcomputer 12051 can calculate a control target value of the driving force generating device, the steering mechanism, or the braking device on the basis of the information on the inside and outside of the vehicle acquired by the vehicle exterior information detection unit 12030 or the vehicle interior information detection unit 12040, and output a control command to the drive system control unit 12010. For example, the microcomputer 12051 can perform cooperative control aiming for implementing functions of advanced driver assistance system (ADAS) including collision avoidance or shock mitigation of the vehicle, follow-up traveling based on an inter-vehicle distance, vehicle speed maintaining traveling, vehicle collision warning, vehicle lane departure warning, or the like.

Furthermore, the microcomputer 12051 can perform cooperative control aiming for automatic driving that autonomously travels without depending on operation of the driver, or the like, by controlling the driving force generating device, the steering mechanism, the braking device, or the like on the basis of information on the periphery of the vehicle acquired by the vehicle exterior information detection unit 12030 or the vehicle interior information detection unit 12040.

Furthermore, the microcomputer 12051 can output a control command to the body system control unit 12020 on the basis of information on the outside of the vehicle acquired by the vehicle exterior information detection unit 12030. For example, the microcomputer 12051 can perform cooperative control aiming for preventing dazzling such as switching from the high beam to the low beam, by controlling the head lamp depending on a position of a preceding vehicle or an oncoming vehicle detected by the vehicle exterior information detection unit 12030.

The audio image output unit 12052 transmits at least one of audio or image output signal to an output device capable of visually or aurally notifying an occupant in the vehicle or the outside of the vehicle of information. In the example of FIG. 15, as the output device, an audio speaker 12061, a display unit 12062, and an instrument panel 12063 are exemplified. The display unit 12062 may include, for example, at least one of an on-board display or a head-up display.

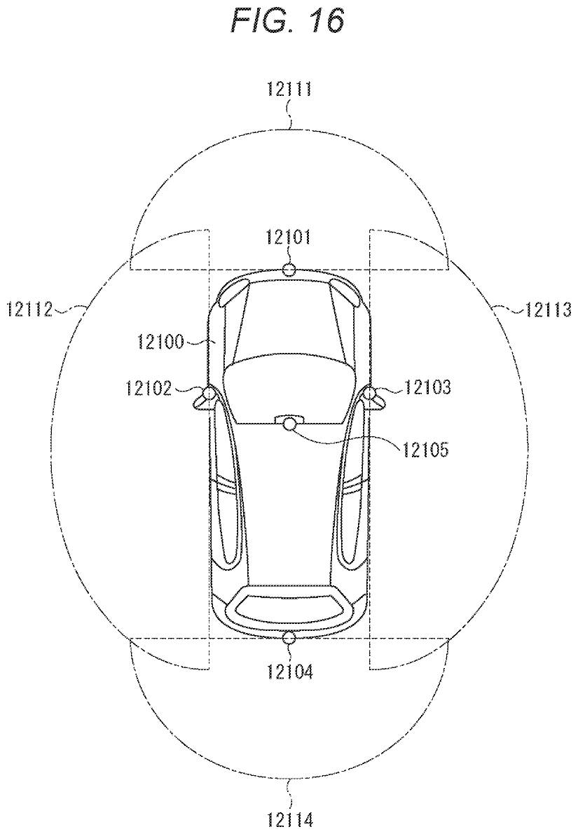

FIG. 16 is a diagram illustrating an example of installation positions of the imaging unit 12031.

In FIG. 16, a vehicle 12100 includes imaging units 12101, 12102, 12103, 12104, and 12105 as the imaging unit 12031.

The imaging units 12101, 12102, 12103, 12104, and 12105 are provided, for example, at a position of the front nose, the side mirror, the rear bumper, the back door, the upper part of the windshield in the vehicle interior, or the like, of a vehicle 12100. The imaging unit 12101 provided at the front nose and the imaging unit 12105 provided at the upper part of the windshield in the vehicle interior mainly acquire images ahead of the vehicle 12100. The imaging units 12102 and 12103 provided at the side mirrors mainly acquire images on the sides of the vehicle 12100. The imaging unit 12104 provided at the rear bumper or the back door mainly acquires an image behind the vehicle 12100. The front images acquired by the imaging units 12101 and 12105 are mainly used for detection of a preceding vehicle, a pedestrian, an obstacle, a traffic signal, a traffic sign, a lane, or the like.

Note that, FIG. 16 illustrates an example of imaging ranges of the imaging units 12101 to 12104. An imaging range 12111 indicates an imaging range of the imaging unit 12101 provided at the front nose, imaging ranges 12112 and 12113 respectively indicate imaging ranges of the imaging units 12102 and 12103 provided at the side mirrors, an imaging range 12114 indicates an imaging range of the imaging unit 12104 provided at the rear bumper or the back door. For example, image data captured by the imaging units 12101 to 12104 are superimposed on each other, whereby an overhead image is obtained of the vehicle 12100 viewed from above.

At least one of the imaging units 12101 to 12104 may have a function of acquiring distance information. For example, at least one of the imaging units 12101 to 12104 may be a stereo camera including a plurality of imaging elements, or may be an imaging element including pixels for phase difference detection.

For example, on the basis of the distance information obtained from the imaging units 12101 to 12104, the microcomputer 12051 obtains a distance to each three-dimensional object within the imaging ranges 12111 to 12114, and a temporal change of the distance (relative speed to the vehicle 12100), thereby being able to extract, as a preceding vehicle, a three-dimensional object that is in particular a closest three-dimensional object on a traveling path of the vehicle 12100 and traveling at a predetermined speed (for example, greater than or equal to 0 km/h) in substantially the same direction as that of the vehicle 12100. Moreover, the microcomputer 12051 can set an inter-vehicle distance to be ensured in advance in front of the preceding vehicle, and can perform automatic brake control (including follow-up stop control), automatic acceleration control (including follow-up start control), and the like. As described above, it is possible to perform cooperative control aiming for automatic driving that autonomously travels without depending on operation of the driver, or the like.

For example, on the basis of the distance information obtained from the imaging units 12101 to 12104, the microcomputer 12051 can extract three-dimensional object data regarding the three-dimensional object by classifying the objects into a two-wheeled vehicle, a regular vehicle, a large vehicle, a pedestrian, and other three-dimensional objects such as a utility pole, and use the data for automatic avoidance of obstacles. For example, the microcomputer 12051 identifies obstacles in the periphery of the vehicle 12100 into an obstacle visually recognizable to the driver of the vehicle 12100 and an obstacle difficult to visually recognize. Then, the microcomputer 12051 determines a collision risk indicating a risk of collision with each obstacle, and when the collision risk is greater than or equal to a set value and there is a possibility of collision, the microcomputer 12051 outputs an alarm to the driver via the audio speaker 12061 and the display unit 12062, or performs forced deceleration or avoidance steering via the drive system control unit 12010, thereby being able to perform driving assistance for collision avoidance.

At least one of the imaging units 12101 to 12104 may be an infrared camera that detects infrared rays. For example, the microcomputer 12051 can recognize a pedestrian by determining whether or not a pedestrian exists in the captured images of the imaging units 12101 to 12104. Such pedestrian recognition is performed by, for example, a procedure of extracting feature points in the captured images of the imaging units 12101 to 12104 as infrared cameras, and a procedure of performing pattern matching processing on a series of feature points indicating a contour of an object to determine whether or not the object is a pedestrian. When the microcomputer 12051 determines that a pedestrian exists in the captured images of the imaging units 12101 to 12104 and recognizes the pedestrian, the audio image output unit 12052 controls the display unit 12062 so that a rectangular contour line for emphasis is superimposed and displayed on the recognized pedestrian. Furthermore, the audio image output unit 12052 may control the display unit 12062 so that an icon or the like indicating the pedestrian is displayed at a desired position.

In the above, an example has been described of the vehicle control system to which the technology according to the present disclosure can be applied. The technology according to the present disclosure can be applied to the vehicle exterior information detection unit 12030 and the vehicle interior information detection unit 12040 among the configurations described above. Specifically, by using distance measurement by the distance measurement module 11 as the vehicle exterior information detection unit 12030 and the vehicle interior information detection unit 12040, it is possible to perform processing of recognizing a gesture of the driver, execute various (for example, an audio system, a navigation system, and an air conditioning system) operations in accordance with the gesture, and more accurately detect the state of the driver. Furthermore, unevenness of the road surface can be recognized by using the distance measurement by the distance measurement module 11 and reflected in control of suspension.

The embodiment of the present technology is not limited to the embodiments described above, and various modifications are possible without departing from the gist of the present technology.

As long as inconsistency does not occur, each of a plurality of the present technologies described in this specification can be implemented alone independently. Of course, it is also possible to implement by combining any of the plurality of present technologies. For example, a part or all of the present technology described in any of the embodiments can be implemented in combination with a part or all of the present technology described in other embodiments. Furthermore, a part or all of any of the present technologies described above can be implemented in combination with another technology not described above.

Furthermore, for example, the configuration described as one device (or processing unit) may be divided and configured as a plurality of devices (or processing units). Conversely, configurations described as a plurality of devices (or processing units) in the above may be collectively configured as one device (or processing unit). Furthermore, configurations other than those described above may be added to the configuration of each device (or each processing unit), of course. Moreover, as long as the configuration and operation of the system as a whole are substantially the same, a part of the configuration of a certain device (or processing unit) may be included in the configuration of another device (or another processing unit).

Moreover, in the present specification, a system means a set of a plurality of constituents (device, module (component), and the like), and it does not matter whether or not all of the constituents are in the same cabinet. Thus, a plurality of devices that is accommodated in a separate cabinet and connected to each other via a network and one device that accommodates a plurality of modules in one cabinet are both systems.

Furthermore, for example, the program described above can be executed in any device. In that case, it is sufficient that the device has a necessary function (functional block, or the like) and can obtain necessary information.

Note that, the effects described in the present specification are merely examples and are not limited, and may have effects other than those described in the present specification.

Note that, the present technology can have the following configurations.

(1)

A distance measurement sensor including

a signal processing unit that calculates a distance to an object and a degree of confidence, from a signal obtained by a light receiving unit that receives reflected light that is returned light obtained by reflecting irradiation light emitted from a predetermined light emitting source by the object, and outputs a determination flag determining whether the object that is an object to be measured is a specular reflector having a high reflectance.

(2)

The distance measurement sensor according to (1), in which

the signal processing unit calculates a reflectance of the object to be measured, by using the distance and the degree of confidence, and extracts an area where there is a possibility that the object to be measured has measured the specular reflector on the basis of the reflectance and the distance.

(3)

The distance measurement sensor according to (2), in which

the area is an area where the distance of the object calculated is within a predetermined distance.

(4)

The distance measurement sensor according to (2) or (3), in which

the signal processing unit determines whether the object is the specular reflector on the basis of a confidence threshold value adaptively changed depending on the reflectance calculated, for the area extracted.

(5)

The distance measurement sensor according to any of (1) to (4), in which

the signal processing unit outputs the determination flag in units of pixels.

(6)

The distance measurement sensor according to any of (1) to (4), in which

the signal processing unit outputs the determination flag in units of depth maps.

(7)

The distance measurement sensor according to any of (1) to (6), in which

the signal processing unit acquires area specifying information that specifies an area, and outputs a determination flag determining whether the object that is an object to be measured is the specular reflector, for the area indicated by the area specifying information.

(8)

A signal processing method in which

a distance measurement sensor

calculates a distance to an object and a degree of confidence, from a signal obtained by a light receiving unit that receives reflected light that is returned light obtained by reflecting irradiation light emitted from a predetermined light emitting source by the object, and outputs a determination flag determining whether the object that is an object to be measured is a specular reflector having a high reflectance.

(9)

A distance measurement module including:

a predetermined light emitting source; and

a distance measurement sensor,

in which

the distance measurement sensor

includes

a signal processing unit that calculates a distance to an object and a degree of confidence, from a signal obtained by a light receiving unit that receives reflected light that is returned light obtained by reflecting irradiation light emitted from a predetermined light emitting source by the object, and outputs a determination flag determining whether the object that is an object to be measured is a specular reflector having a high reflectance.

### REFERENCE SIGNS LIST

11 Distance measurement module
12 Light emitting unit
13 Light emission control unit
14 Distance measurement sensor
15 Light receiving unit
16 Signal processing unit
21 Object
101 Smartphone
102 Distance measurement module

1. A distance measurement sensor comprising
a signal processing unit that calculates a distance to an object and a degree of confidence, from a signal obtained by a light receiving unit that receives reflected light that is returned light obtained by reflecting irradiation light emitted from a predetermined light emitting source by the object, and outputs a determination flag determining whether the object that is an object to be measured is a specular reflector having a high reflectance.

2. The distance measurement sensor according to claim 1, wherein
the signal processing unit calculates a reflectance of the object to be measured, by using the distance and the degree of confidence, and extracts an area where there is a possibility that the object to be measured has measured the specular reflector on a basis of the reflectance and the distance.

3. The distance measurement sensor according to claim 2, wherein
the area is an area where the distance of the object calculated is within a predetermined distance.

4. The distance measurement sensor according to claim 2, wherein
the signal processing unit determines whether the object is the specular reflector on a basis of a confidence threshold value adaptively changed depending on the reflectance calculated, for the area extracted.

5. The distance measurement sensor according to claim 1, wherein
the signal processing unit outputs the determination flag in units of pixels.

6. The distance measurement sensor according to claim 1, wherein
the signal processing unit outputs the determination flag in units of depth maps.

7. The distance measurement sensor according to claim 1, wherein
the signal processing unit acquires area specifying information that specifies an area, and outputs a determination flag determining whether the object that is an object to be measured is the specular reflector, for the area indicated by the area specifying information.

8. A signal processing method in which
a distance measurement sensor
calculates a distance to an object and a degree of confidence, from a signal obtained by a light receiving unit that receives reflected light that is returned light obtained by reflecting irradiation light emitted from a predetermined light emitting source by the object, and outputs a determination flag determining whether the object that is an object to be measured is a specular reflector having a high reflectance.

9. A distance measurement module comprising:
a predetermined light emitting source; and
a distance measurement sensor,
wherein
the distance measurement sensor
includes
a signal processing unit that calculates a distance to an object and a degree of confidence, from a signal obtained by a light receiving unit that receives reflected light that is returned light obtained by reflecting irradiation light emitted from a predetermined light emitting source by the object, and outputs a determination flag determining whether the object that is an object to be measured is a specular reflector having a high reflectance.
